(19) United States
(12) Patent Application Publication
(10) Pub. No.: US 2020/0318588 A1
(43) Pub. Date: Oct. 8, 2020

(54) HYBRID VEHICLE AND METHOD OF DIAGNOSING ABNORMAL CONDITION OF HYBRID VEHICLE

(71) Applicant: TOYOTA JIDOSHA KABUSHIKI KAISHA, Toyota-shi (JP)

(72) Inventors: Koichi YONEZAWA, Toyota-shi (JP); Satoshi Yoshizaki, Gotenba-shi (JP); Osamu Maeda, Toyota-shi (JP); Daigo Ando, Nagoya-shi (JP); Yoshikazu Asami, Gotenba-shi (JP); Kenji Itagaki, Suntou-gun (JP); Shunsuke Oyama, Nagakute-shi (JP); Koichiro Muta, Okazaki-shi (JP)

(73) Assignee: TOYOTA JIDOSHA KABUSHIKI KAISHA, Toyota-shi (JP)

(21) Appl. No.: 16/821,403

(22) Filed: Mar. 17, 2020

(30) Foreign Application Priority Data
Apr. 3, 2019 (JP) 2019-071051

(51) Int. Cl. F02M 35/10

(52) U.S. Cl. CPC F02M 35/10386; F02M 2700/05; F02M 35/10157; F02M 35/1038

(57) ABSTRACT

A vehicle includes an engine, a first motor generator coupled to the engine, and an HV-ECU that performs motoring control of rotating a crankshaft of the engine by the first motor generator. The engine includes an intake air passage, a forced induction device provided in the intake air passage, and an air flow meter that detects a flow rate of air (suctioned air amount) that passes through the intake air passage. The HV-ECU diagnoses air leakage as occurring in the intake air passage when the suctioned air amount is less than a reference amount during the motoring control.

This nonprovisional application is based on Japanese Patent Application No. 2019-071051 filed on Apr. 3, 2019 with the Japan Patent Office, the entire contents of which are hereby incorporated by reference.

### BACKGROUND

### Field

The present disclosure relates to a hybrid vehicle and a method of controlling the same, and more particularly, to a hybrid vehicle including an engine with a forced induction device and a method of diagnosing an abnormal condition of the hybrid vehicle.

### Description of the Background Art

An engine with a forced induction device is publicly known. Increasing torque in a low-rotation area by the forced induction device can reduce displacement while maintaining equivalent power, thus improving fuel consumption of a vehicle. For example, the hybrid vehicle disclosed in Japanese Patent Laying-Open No. 2015-58924 includes an engine with a turbo forced induction device, and a motor generator.

### SUMMARY

In a hybrid vehicle including an engine with a forced induction device, a compressor, an intercooler, and a throttle valve are provided in an intake air passage to the engine. The intake air passage to the engine includes, for example, a first hose (intake pipe) connecting the compressor to the intercooler, and a second hose connecting the intercooler to the throttle valve. Each hose is fastened to devices at its opposite ends by a band, for example.

While the forced induction device is operating, an intake air passage (first and second hoses) downstream of the compressor is pressurized along with the rotation of the compressor. Thus, an internal pressure of the intake air passage provided in the engine with a forced induction device is higher than the internal pressure of the intake air passage provided in a naturally aspirated engine. As a result, a connected portion (fastened by a band) of any hose may become detached, and the hose may be disconnected. In any other case, the hose may be broken or cracked due to age deterioration of the hose or various external factors. If air leakage occurs in the intake air passage due to an abnormal condition of the hose (disconnection, breakage, or cracking of the hose), no matter how much air is drawn, an appropriate amount of air cannot be delivered to the engine, which may lead to an engine stall.

In such a case, it is desirable that a cause of the engine stall can be diagnosed as air leakage in the intake air passage. This allows for a prompt repair of a failed part when, for example, a vehicle is bought to a repair shop or the like.

The present disclosure has been made to solve such a problem, and an object of the present disclosure is to diagnose the presence or absence of air leakage in an intake air passage.

(1) A hybrid vehicle according to an aspect of the present disclosure includes an engine and a controller that performs motoring control of rotating a crankshaft of the engine by a motor. The engine includes an intake air passage, a forced induction device provided in the intake air passage, and a flow meter that detects a flow rate of air that passes through the intake air passage. When the flow rate of air detected by the flow meter during the motoring control is less than a reference amount, the controller diagnoses air leakage as occurring in the intake air passage.

(2) When the engine is stalled, the controller performs the motoring control to diagnose presence or absence of an occurrence of air leakage in the intake air passage.

(3) The forced induction device includes a compressor that compresses intake air to the intake air passage. The engine further includes an intercooler that is provided downstream of the compressor in the intake air passage and cools air that passes through the intake air passage, and a throttle valve that is provided downstream of the compressor in the intake air passage and regulates the flow rate of air that passes through the intake air passage. The intake air passage includes a hose connecting two of the compressor, the intercooler, and the throttle valve to each other. The air leakage occurs due to an abnormal condition of the hose in the intake air passage.

In the configurations of (1) to (3) above, motoring control is performed when, for example, the engine is stalled. The engine is forcibly rotated by this motoring control. When the intake air passage is in normal state, an airflow is formed in the intake air passage (e.g., hose) along with the rotation of the engine. Contrastingly, when air leakage has occurred in the intake air passage, an airflow is less easily formed in the intake air passage even when the engine rotates. With the configurations of (1) to (3) above, thus, when the flow rate of air detected by the flow meter during the motoring control is less than the reference amount, a diagnosis of air leakage as occurring in the intake air passage can be made.

(4) The hybrid vehicle further includes an intake pressure sensor that detects a pressure in an intake manifold of the engine. Before diagnosing air leakage as occurring, the controller controls a fuel injection amount of the engine based on a detection result of the flow meter, and after diagnosing air leakage as occurring, the controller controls the fuel injection amount based on a detection result of the intake pressure sensor.

When air leakage occurs in the intake air passage, the flow rate of air detected by the flow meter does not match the flow rate of air delivered to the engine, and accordingly, a fuel injection amount cannot be controlled with high accuracy based on the detection result of the flow meter. With the configuration of (4) above, after the diagnosis of the occurrence of air leakage, the fuel injection amount is controlled based on the detection result of the intake pressure sensor installed in the intake manifold. The fuel injection amount can thus be controlled with high accuracy, which allows for retreat traveling for a longer distance. This enables, for example, a vehicle to be taken to a repair shop or the like to repair air leakage. In other words, a fail-safe function can be achieved.

(5) In a method of diagnosing an abnormal condition of a hybrid vehicle according to another aspect of the present disclosure, the hybrid vehicle includes an engine and a motor coupled to the engine. The engine includes an intake air passage, a forced induction device provided in the intake air passage, and a flow meter that detects a flow rate of air that passes through the intake air passage. The method includes performing motoring control of rotating a crankshaft of the engine by the motor, and diagnosing air leakage as occurring in the intake air passage when the flow rate of air detected by the flow meter during the motoring control is less than a reference amount.

The method of (5) above can diagnose the presence or absence of air leakage in the intake air passage similarly to the configuration (1) above.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows a general configuration of a hybrid vehicle according to an embodiment of the present disclosure.

FIG. 2 shows an example configuration of an engine.

FIG. 3 shows an example configuration of a control system of a vehicle.

FIG. 4 is a nomographic chart for illustrating an air leakage diagnosis process in the present embodiment.

FIG. 5 is a flowchart showing an example of the air leakage diagnosis process.

### DESCRIPTION OF THE PREFERRED EMBODIMENTS

The present embodiment will now be described in detail with reference to the drawings. The same or corresponding elements will be designated by the same reference numerals in the drawings, the description of which will not be repeated.

### EMBODIMENT

<Configuration of Hybrid Vehicle>

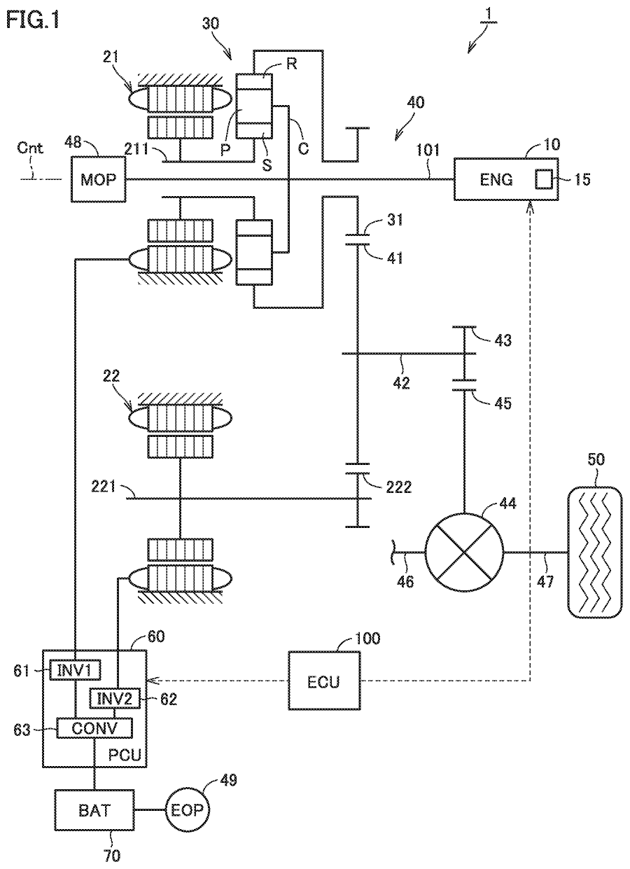

FIG. 1 shows a general configuration of a hybrid vehicle according to an embodiment of the present disclosure. Referring to FIG. 1, a vehicle 1 is a hybrid vehicle and includes an engine 10, a first motor generator 21, a second motor generator 22, a planetary gear mechanism 30, a drive device 40, a driving wheel 50, a power control unit (PCU) 60, a battery 70, and an electronic control unit (ECU) 100.

Engine 10 is an internal-combustion engine, such as a gasoline engine. Engine 10 generates motive power for vehicle 1 to travel in accordance with a control signal from ECU 100.

Each of first motor generator 21 and second motor generator 22 is a permanent magnet synchronous motor or an induction motor. First motor generator 21 and second motor generator 22 have rotor shafts 211 and 221, respectively.

First motor generator 21 uses the electric power of battery 70 to rotate a crankshaft (not shown) of engine 10 at startup of engine 10. First motor generator 21 can also use the motive power of engine 10 to generate electric power. Alternating current (AC) power generated by first motor generator 21 is converted into direct current (DC) power by PCU 60, with which charge battery 70 is charged. AC power generated by first motor generator 21 may also be supplied to second motor generator 22. First motor generator 21 corresponds to the “motor” according to the present disclosure.

Second motor generator 22 uses at least one of the electric power from battery 70 and the electric power generated by first motor generator 21 to rotate drive shafts 46 and 47 (which will be described below). Second motor generator 22 can also generate electric power by regenerative braking. AC power generated by second motor generator 22 is converted into DC power by PCU 60, with which battery 70 is charged.

Planetary gear mechanism 30 is a single-pinion planetary gear mechanism and is arranged on an axis Cnt coaxial with an output shaft 101 of engine 10. Planetary gear mechanism 30 transmits a torque output from engine 10 while dividing the torque to first motor generator 21 and an output gear 31. Planetary gear mechanism 30 includes a sun gear S, a ring gear R, pinion gears P, and a carrier C.

Ring gear R is arranged coaxially with sun gear S. Pinion gears P mesh with sun gear S and ring gear R. Carrier C holds pinion gears P in a rotatable and revolvable manner. Each of engine 10 and first motor generator 21 is mechanically coupled to driving wheel 50 with planetary gear mechanism 30 therebetween. Output shaft 101 of engine 10 is coupled to carrier C. Rotor shaft 211 of first motor generator 21 is coupled to sun gear S. Ring gear R is coupled to output gear 31.

In planetary gear mechanism 30, carrier C functions as an input element, ring gear R functions as an output element, and sun gear S functions as a reaction force element. Carrier C receives a torque output from engine 10. Planetary gear mechanism 30 transmits a torque output from engine 10 to output shaft 101 while dividing the torque to sun gear S (and also first motor generator 21) and ring gear R (and also output gear 31). A reaction torque generated by first motor generator 21 acts on sun gear S. Ring gear R outputs a torque to output gear 31.

Drive device 40 includes a driven gear 41, a countershaft 42, a drive gear 43, and a differential gear 44. Differential gear 44 corresponds to a final reduction gear and has a ring gear 45. Drive device 40 further includes drive shafts 46 and 47, an oil pump 48, and an electric oil pump 49.

Driven gear 41 is meshed with output gear 31 coupled to ring gear R of planetary gear mechanism 30. Driven gear 41 is also meshed with a drive gear 222 attached to rotor shaft 221 of second motor generator 22. Countershaft 42 is attached to driven gear 41 and is arranged in parallel with axis Cnt. Drive gear 43 is attached to countershaft 42 and is meshed with ring gear 45 of differential gear 44. In drive device 40 having the configuration described above, driven gear 41 operates to combine a torque output from second motor generator 22 to rotor shaft 221 and a torque output from ring gear R included in planetary gear mechanism 30 to output gear 31. A resultant drive torque is transmitted to driving wheel 50 through drive shafts 46 and 47 extending laterally from differential gear 44.

Oil pump 48 is, for example, a mechanical oil pump. Oil pump 48 is provided coaxially with output shaft 101 of engine 10 and is driven by engine 10. Oil pump 48 feeds a lubricant to planetary gear mechanism 30, first motor generator 21, second motor generator 22, and differential gear 44 while engine 10 is operating.

Electric oil pump 49 is driven by electric power supplied from battery 70 or another vehicle-mounted battery (e.g., auxiliary battery), which is not shown. Electric oil pump 49 feeds a lubricant to planetary gear mechanism 30, first motor generator 21, second motor generator 22, and differential gear 44 while engine 10 is at rest.

PCU 60 converts DC power stored in battery 70 into AC power and supplies the AC power to first motor generator 21 and second motor generator 22, in response to a control signal from ECU 100. PCU 60 also converts AC power generated by first motor generator 21 and second motor generator 22 into DC power and supplies the DC power to battery 70. PCU 60 includes a first inverter 61, a second inverter 62, and a converter 63.

First inverter 61 converts a DC voltage into an AC voltage and drives first motor generator 21, in response to a control signal from ECU 100. Second inverter 62 converts a DC voltage into an AC voltage and drives second motor generator 22, in response to a control signal from ECU 100. Converter 63 steps up a voltage supplied from battery 70 and supplies the voltage to first inverter 61 and second inverter 62, in response to a control signal from ECU 100. Converter 63 also steps down a DC voltage from either one or both of first inverter 61 and second inverter 62 and charges battery 70, in response to a control signal from ECU 100.

Battery 70 includes a secondary battery, such as a lithium ion secondary battery or a nickel-hydrogen battery. The battery may be a capacitor, such as an electric double layer capacitor.

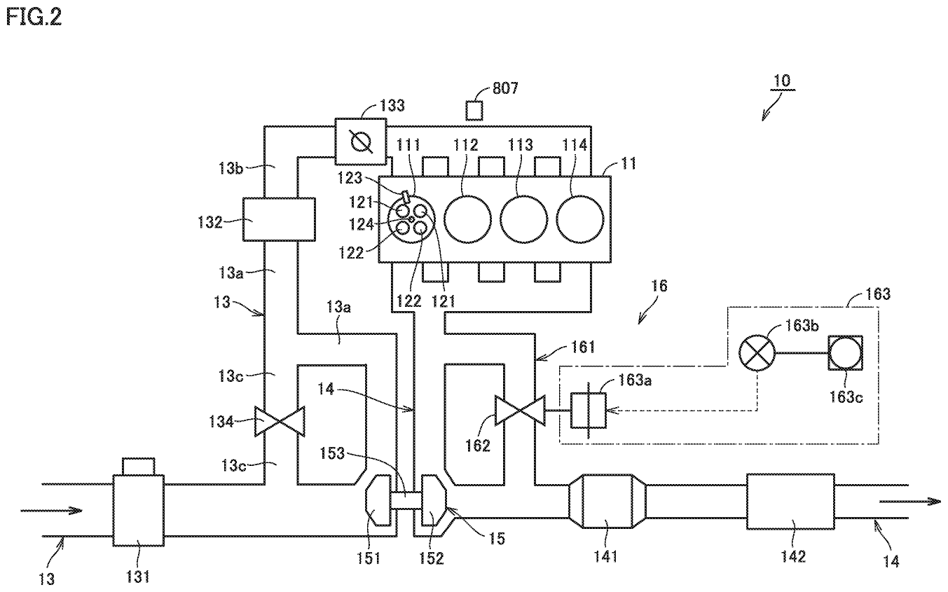

ECU 100 is composed of, for example, a central processing unit (CPU), a memory, an I/O port, and a counter, all of which are not shown. The CPU executes a control program. The memory stores, for example, various control programs and maps. The I/O port controls the transmission and reception of various signals. The counter counts a time. ECU 100 outputs a control signal and controls various devices such that vehicle 1 enters the desired state, based on a signal input from each sensor (described below), and the control program and map stored in the memory. Examples of main processes performed by ECU 100 include an “air leakage diagnosis process” of diagnosing the presence or absence of air leakage in an intake air passage 13 of engine 10 (see FIG. 2). The air leakage diagnosis process will be described below in detail.

<Configuration of Engine>

FIG. 2 shows an example configuration of engine 10. Referring to FIG. 2, engine 10 is, for example, an in-line four-cylinder spark ignition internal combustion engine. Engine 10 includes an engine main body 11. Engine main body 11 includes four cylinders 111 to 114. Four cylinders 111 to 114 are aligned in one direction. Since cylinders 111 to 114 have the same configuration, the configuration of cylinder 111 will be representatively described below.

Cylinder 111 is provided with two intake valves 121, two exhaust valves 122, an injector 123, and an ignition plug 124. Cylinder 111 is connected with intake air passage 13 and an exhaust passage 14. Intake air passage 13 is opened and closed by intake valves 121. Exhaust passage 14 is opened and closed by exhaust valves 122. Fuel (e.g., gasoline) is added to air supplied through intake air passage 13 to engine main body 11, thus generating an air-fuel mixture of the air and the fuel. The fuel is injected in cylinder 111 by injector 123, thus generating the air-fuel mixture in cylinder 111. Then, ignition plug 124 ignites the air-fuel mixture in cylinder 111. Thus, the air-fuel mixture is burned in cylinder 111. The energy of combustion which occurs through the combustion of the air-fuel mixture in cylinder 111 is converted into kinetic energy by a piston (not shown) within cylinder 111 and is output to output shaft 101 (see FIG. 1).

Engine 10 further includes a turbo forced induction device 15. Forced induction device 15 is a turbocharger that uses exhaust energy to boost suctioned air. Forced induction device 15 includes a compressor 151, a turbine 152, and a shaft 153.

Forced induction device 15 uses exhaust energy to rotate turbine 152 and compressor 151, thereby boosting suctioned air (i.e., increasing the density of air suctioned into engine main body 11). More specifically, compressor 151 is disposed in intake air passage 13, and turbine 152 is disposed in exhaust passage 14. Compressor 151 and turbine 152 are coupled to each other with shaft 153 therebetween to rotate together. Turbine 152 rotates by a flow of exhaust discharged from engine main body 11. The rotative force of turbine 152 is transmitted to compressor 151 through shaft 153 to rotate compressor 151. The rotation of compressor 151 compresses intake air that flows toward engine main body 11, and the compressed air is supplied to engine main body 11.

Upstream of compressor 151 in intake air passage 13, an air flow meter (AFM) 131 is provided. Downstream of compressor 151 in intake air passage 13, an intercooler 132 is provided. Downstream of intercooler 132 in intake air passage 13, a throttle valve (intake throttle valve) 133 is provided. Thus, the air that flows into intake air passage 13 is supplied to each of cylinders 111 to 114 of engine main body 11 through air flow meter 131, compressor 151, intercooler 132, and throttle valve 133 in the stated order.

Air flow meter 131 outputs a signal corresponding to a flow rate of air that flows through intake air passage 13. Intercooler 132 cools intake air compressed by compressor 151. Throttle valve 133 can regulate a flow rate of intake air that flows through intake air passage 13. Air flow meter 131 corresponds to the “flow meter” according to the present disclosure.

The configuration of intake air passage 13 in the present embodiment will be described in more detail. Intake air passage 13 includes a first hose 13a, a second hose 13b, and a third hose 13c.

First hose 13a connects compressor 151 and intercooler 132 to each other. A first end of first hose 13a and compressor 151 are fastened to each other by a band, and also, a second end of first hose 13a and intercooler 132 are fastened to each other by a band.

Second hose 13b connects intercooler 132 and throttle valve 133 to each other. Similarly to first hose 13a, a first end of second hose 13b and intercooler 132 are fastened to each other by a band, and also, a second end of second hose 13b and throttle valve 133 are fastened to each other by a band. Either one or both of first hose 13a and second hose 13b correspond to the “hose” according to the present disclosure.

Third hose 13c connects an upstream side of compressor 151 and a downstream side of compressor 151 to each other, that is, bypasses compressor 151. Third hose 13c is provided with an air bypass vale (ABV) 134. Air bypass vale 134 is opened to divert air, which flows through intake air passage 13, around compressor 151.

Downstream of turbine 152 in exhaust passage 14, a start-up catalyst converter 141 and an aftertreatment device 142 are provided. Further, exhaust passage 14 is further provided with a WGV device 16. WGV device 16 can flow exhaust discharged from engine main body 11 while diverting the exhaust around turbine 152 and regulate the amount of exhaust to be diverted. WGV device 16 includes a bypass passage 161, a waste gate valve (WGV) 162, and a WGV actuator 163.

Bypass passage 161 is connected to exhaust passage 14 and flows exhaust while diverting the exhaust around turbine 152. Specifically, bypass passage 161 is branched from a portion upstream of turbine 152 in exhaust passage 14 (e.g., between engine main body 11 and turbine 152) and meets a portion downstream of turbine 152 in exhaust passage 14 (e.g., between turbine 152 and start-up catalyst converter 141).

WGV 162 is disposed in bypass passage 161. WGV 162 can regulate a flow rate of exhaust guided from engine main body 11 to bypass passage 161 depending on its opening. As WGV 162 is closed by a larger amount, the flow rate of exhaust guided from engine main body 11 to bypass passage 161 decreases, whereas the flow rate of exhaust that flows into turbine 152 increases, leading to a higher pressure of suctioned air (i.e., boost pressure).

WGV 162 is a negative-pressure valve driven by WGV actuator 163. WGV actuator 163 includes a negative-pressure-driven diaphragm 163a, a negative pressure regulating valve 163b, and a negative pressure pump 163c.

Diaphragm 163a is coupled to WGV 162. WGV 162 is driven by a negative pressure introduced into diaphragm 163a. In the present embodiment, WGV 162 is a normally closed valve, and the opening of WGV 162 increases as a higher negative pressure acts on diaphragm 163a.

Negative pressure regulating valve 163b is a valve that can adjust the magnitude of a negative pressure acting on diaphragm 163a. A larger opening of negative pressure regulating valve 163b leads to a higher negative pressure acting on diaphragm 163a. Negative pressure regulating valve 163b can be a two position electromagnetic valve that can be alternatively selected to be fully open or fully closed. Negative pressure pump 163c is connected to diaphragm 163a with pressure-regulating valve 163b therebetween. Negative pressure pump 163c is a mechanical pump (e.g., vane-type mechanical pump) driven by engine 10. Negative pressure pump 163c uses the motive power output to output shaft 101 of engine 10 (see FIG. 1) to generate a negative pressure. Negative pressure pump 163c becomes activated while engine 10 is operating, and when engine 10 stops, negative pressure pump 163c also stops. Note that WGV 162 is not necessarily a valve of diaphragm negative pressure type and may be a valve driven by an electric actuator.

Exhaust discharged from engine main body 11 passes through any one of turbine 152 and WGV 162. Each of start-up catalyst converter 141 and aftertreatment device 142 includes, for example, a three-way catalyst and removes a hazardous substance in the exhaust. More specifically, since start-up catalyst converter 141 is provided at an upstream portion (a portion close to the combustion chamber) of exhaust passage 14, its temperature rises to the activation temperature in a short period of time after startup of engine 10. Aftertreatment device 142 located downstream purifies HC, CO, and NOx that were not purified by start-up catalyst converter 141.

<Configuration of Control System>

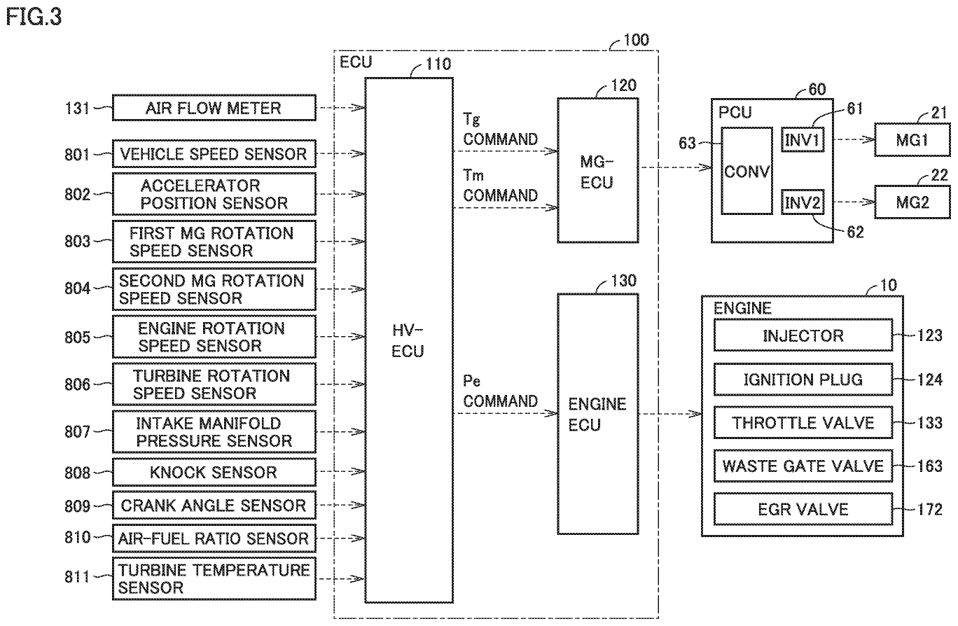

FIG. 3 shows an example configuration of a control system of vehicle 1. Referring to FIG. 3, vehicle 1 includes a vehicle speed sensor 801, an accelerator position sensor 802, a first motor generator rotation speed sensor 803, a second motor generator rotation speed sensor 804, an engine rotation speed sensor 805, a turbine rotation speed sensor 806, an intake manifold pressure sensor 807, a knock sensor 808, a crank angle sensor 809, an air-fuel ratio sensor 810, and a turbine temperature sensor 811. ECU 100 includes an HV-ECU 110, an MG-ECU 120, and an engine ECU 130.

Vehicle speed sensor 801 detects a speed of vehicle 1. Accelerator position sensor 802 detects an amount of pressing of an accelerator pedal. First motor generator rotation speed sensor 803 detects a rotation speed of first motor generator 21. Second motor generator rotation speed sensor 804 detects a rotation speed of second motor generator 22. Engine rotation speed sensor 805 detects a rotation speed (engine rotation speed Ne) of output shaft 101 of engine 10. Turbine rotation speed sensor 806 detects a rotation speed of turbine 152 of forced induction device 15. Intake manifold pressure sensor 807 detects a pressure in an intake manifold 11a (intake manifold pressure P) of engine 10. Knock sensor 808 detects an occurrence of nocking in engine 10 (vibrations of engine main body 11). Crank angle sensor 809 detects a rotation angle of the crankshaft (not shown) of engine 10. Air-fuel ratio sensor 810 detects a concentration of oxygen (an air-fuel ratio of an air-fuel mixture) in exhaust. Turbine temperature sensor 811 detects a temperature of turbine 152. Each sensor outputs a signal indicating a detection result to HV-ECU 110.

HV-ECU 110 cooperatively controls engine 10, first motor generator 21, and second motor generator 22. More specifically, HV-ECU 110 first determines a requested driving force in accordance with, for example, an accelerator position and a vehicle speed and calculates requested power of engine 10 from the requested driving force. HV-ECU 110 determines, from the requested power of engine 10, an engine operating point (a combination of engine rotation speed Ne and an engine torque Te), at which, for example, the smallest fuel consumption of engine 10 is obtained. HV-ECU 110 then outputs various commands such that engine 10 operates at the engine operating point. Specifically, HV-ECU 110 outputs, to MG-ECU 120, a command (Tg command) for instructing a torque Tg to be generated by first motor generator 21 and a command (Tm command) for instructing a torque Tm to be generated by second motor generator 22. HV-ECU 110 also outputs, to engine ECU 130, a command (Pe command) for instructing power (engine power) Pe to be generated by engine 10.

Based on the commands (Tg command and Tm command) from HV-ECU 110, MG-ECU 120 generates signals for driving first motor generator 21 and second motor generator 22 and outputs the signals to PCU 60. Engine ECU 130 controls each component of engine 10 (e.g., injector 123, ignition plug 124, throttle valve 133, WGV 162, EGR valve 172) based on the Pe command from HV-ECU 110.

HV-ECU 110 requests boosting suctioned air by turbo forced induction device 15 or requests increasing a boost pressure along with an increase in engine torque Te. A boost request (and a boost pressure increase request) is output to engine ECU 130. Engine ECU 130 controls WGV 162 in accordance with the boost request from HV-ECU 110.

FIG. 3 shows an example in which ECU 100 is configured separately for HV-ECU 110, MG-ECU 120, and engine ECU 130 by function. However, ECU 100 is not necessarily configured separately by function and may include one or two ECUs.

<Air Leakage Diagnosis Process>

In vehicle 1 configured as described above, while forced induction device 15 is operating, intake air passage 13 (first hose 13a and second hose 13b) downstream of compressor 151 is pressurized along with the rotation of compressor 151. Thus, the internal pressure of intake air passage 13 is higher than the internal pressure of an intake air passage (not shown) provided in a naturally aspirated engine. As a result, either one or both of the bands provided at the opposite ends of first hose 13a may become detached, and first hose 13a may be disconnected (disconnection of hose). In any other case, either one or both of the bands provided at the opposite ends of second hose 13b may become detached, and second hose 13b may be disconnected. Intake air passage 13 may be broken or cracked due to aging deterioration of intake air passage 13 or various external factors. If air leakage occurs in intake air passage 13 due to such an abnormal condition of the hose in intake air passage 13, no matter how much air is drawn, an appropriate amount of air cannot be delivered to engine main body 11, which may result in an engine stall.

In the present embodiment, thus, upon occurrence of an engine stall, HV-ECU 110 diagnoses whether air leakage has occurred in intake air passage 13 at the next startup of the engine (air leakage diagnosis process). More specifically, HV-ECU 110 performs motoring control upon restart of engine 10 and obtains a flow rate of air (suctioned air amount Q) that flows through intake air passage 13 during motoring control, as described below. HV-ECU 110 then diagnoses the presence or absence of an occurrence of air leakage in intake air passage 13 based on suctioned air amount Q.

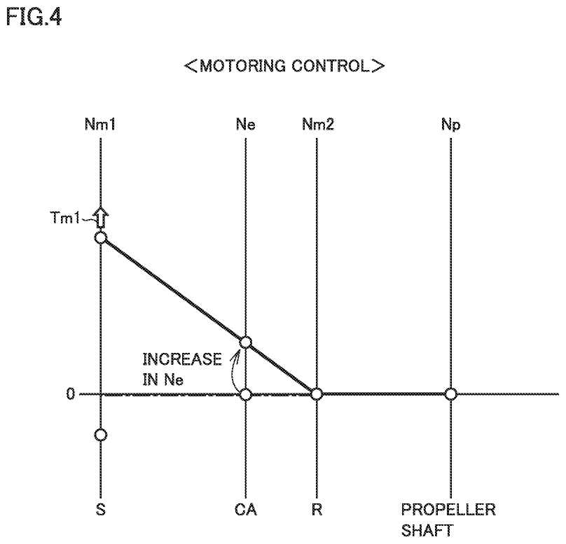

FIG. 4 is a nomographic chart for illustrating the air leakage diagnosis process in the present embodiment. The state of vehicle 1 in which an engine stall has occurred is indicated by an alternate long and short dash line. For example, when the situation in which the user presses the accelerator pedal to restart engine 10 develops after the occurrence of an engine stall, motoring control is performed in the present embodiment. As indicated by the solid line, a torque Tg in the positive direction is output from first motor generator 21 by this motoring control, thus forcibly rotating engine 10.

When intake air passage 13 is in normal state (i.e., when no abnormal condition has occurred in the hose), an airflow is formed in intake air passage 13 as engine 10 is rotated to increase engine rotation speed Ne. Contrastingly, when an abnormal condition has occurred in the hose, an airflow is less easily formed in intake air passage 13 even if engine rotation speed Ne is increased.

In the present embodiment, HV-ECU 110 detects a flow rate of air (suctioned air amount Q) that flows through intake air passage 13 during motoring control with air flow meter 131 and compares the detected suctioned air amount Q with a reference amount REF. When suctioned air amount Q is less than reference amount REF, HV-ECU 110 determines that a sufficient airflow has not been formed and diagnoses an abnormal condition as occurring in the hose. Contrastingly, when suctioned air amount Q is more than reference amount REF, HV-ECU 110 determines that a sufficient airflow has been formed and diagnoses no abnormal condition as occurring in the hose and intake air passage 13 as normal. Thus, when it can be identified that the engine stall is due to an abnormal condition of the hose, a repair worker can immediately repair the hose as, for example, vehicle 1 is taken to a repair shop or the like.

Even if engine 10 is forcibly rotated by motoring control, when an amount of increase in engine rotation speed Ne is small (e.g., about 100 rotations per minute (rpm)), an airflow is less easily formed in intake air passage 13 even though intake air passage 13 is in normal state. As a result, a diagnosis of an abnormal condition as occurring in the hose may be made by mistake even though intake air passage 13 is actually in normal state. It is thus desired that HV-ECU 110 perform motoring control such that engine rotation speed Ne increases to about the engine rotation speed during idling (e.g., about 1000 rpm) or higher speed.

The present embodiment has described the configuration in which vehicle 1 includes two motors (first motor generator 21 and second motor generator 22) by way of example. Alternatively, vehicle 1 may include only one motor as long as engine rotation speed Ne can be increased to several hundred rpm to 1000 rpm or more by motoring control.

<Control Flow>

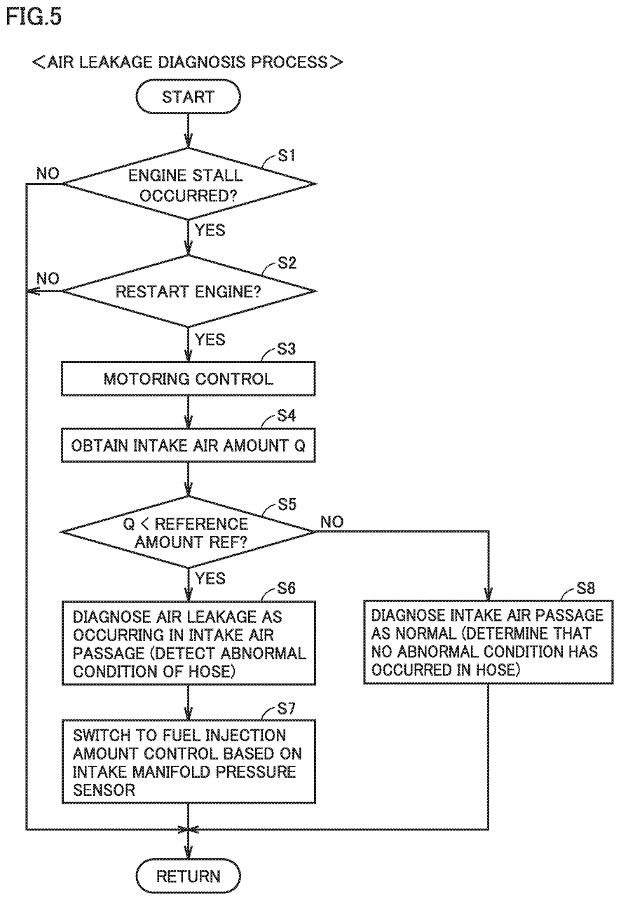

FIG. 5 is a flowchart showing an example of the air leakage diagnosis process. A series of processes shown in this flowchart are repeatedly performed for each predetermined control period in HV-ECU 110. Each step (hereinafter abbreviated as S) is basically implemented through a software process by HV-ECU 110, which may be implemented through a hardware process by an electronic circuit fabricated in HV-ECU 110. Some of the series of processes may be implemented through the processes in engine ECU 130 in place of HV-ECU 110.

Referring to FIG. 5, at S1, HV-ECU 110 (which may be engine ECU 130) determines whether an engine stall has occurred during operation of engine 10. When engine rotation speed Ne decreases to be equal to or lower than a predetermined rotation number even though engine 10 is operating, HV-ECU 110 can determine that an engine stall has occurred. However, the way of determining an engine stall is not limited to the above, and for example, the generation of an engine stall may be determined based on a cam angle signal of a cam angle sensor (not shown), or these ways may be combined together.

When an engine stall has occurred (YES at S1), HV-ECU 110 determines whether a predetermined condition (diagnosis condition) for diagnosing the presence or absence of an abnormal condition in engine 10 is satisfied (S2). For example, it is determined that the diagnosis condition is satisfied when an amount of pressing of the accelerator pedal by the user is more than a predetermined amount and engine 10 is to be restarted. The satisfaction of this diagnosis condition does not necessarily involve a user's operation, and it may be determined that the diagnosis condition is satisfied irrespective of a user's operation and YES determination may be made at S2. For example, YES determination may be made when a predetermined period of time has elapsed from the occurrence of the engine stall.

When the abnormal condition diagnosis condition of engine 10 is satisfied (YES at S2), HV-ECU 110 outputs a command for performing motoring control to MG-ECU 120 (S3). HV-ECU 110 (which may be engine ECU 130) further obtains a flow rate of air (suctioned air amount Q) detected by air flow meter 131 during motoring control (S4). HV-ECU 110 (which may be engine ECU 130) then determines whether the obtained suctioned air amount Q is less than a predetermined reference amount REF, which is a predetermined conformance constant (S5). Note that reference amount REF is not limited to a fixed amount and may be an amount of intake air (i.e., variable amount) of engine 10 which is estimated from intake manifold pressure P and/or throttle opening.

When suctioned air amount Q is greater than or equal to reference amount REF at S5 (NO at S5), HV-ECU 110 determines that an airflow associated with the forcible rotation of engine 10 has been detected normally and diagnoses intake air passage 13 as normal (S8). In other words, HV-ECU 110 determines that an abnormal condition of the hose in intake air passage 13 has not been detected.

Contrastingly, when suctioned air amount Q is less than reference amount REF (YES at S5), HV-ECU 110 determines that an airflow has not been detected due to air leakage and diagnoses an abnormal condition as occurring in intake air passage 13 (S6). In other words, HV-ECU 110 detects an abnormal condition of the hose in intake air passage 13.

At S7, HV-ECU 110 outputs, to engine ECU 130, a command for switching control of a fuel injection amount of engine 10 from control based on air flow meter 131 to control based on intake manifold pressure sensor 807. Engine ECU 130 normally controls a fuel injection amount based on suctioned air amount Q detected by air flow meter 131. More specifically, engine ECU 130 calculates a cylinder-filling air amount M from suctioned air amount Q detected by air flow meter 131 and engine rotation speed Ne. Engine ECU 130 then divides cylinder-filling air amount M by a target air-fuel ratio to calculate a fundamental fuel injection amount. Engine ECU 130 then multiplies the fundamental fuel injection amount by a coefficient K to calculate a fuel injection amount. Coefficient K is set based on, for example, an air-fuel ratio of exhaust gas obtained from air-fuel ratio sensor 810.

When an abnormal condition occurs in the hose, the amount of air actually delivered to engine main body 11 becomes smaller than actual suctioned air amount Q detected by air flow meter 131, so that cylinder-filling air amount M cannot be obtained accurately based on suctioned air amount Q. Engine ECU 130 thus refers to intake manifold pressure P detected by intake manifold pressure sensor 807, engine rotation speed Ne, an intake and exhaust valve timing (IN and EX-VVT), and a map MP where a boost pressure or the like is an argument, thereby calculating cylinder-filling air amount M from intake manifold pressure P, engine rotation speed Ne, and the like. Further, engine ECU 130 divides cylinder-filling air amount M by the target air-fuel ratio to calculate a fundamental fuel injection amount, and multiplies the fundamental fuel injection amount by coefficient K to calculate a fuel injection amount. Consequently, the fuel injection amount can be controlled with high accuracy, allowing for retreat traveling for a longer distance (fail-safe function). As a result, vehicle 1 can be more easily taken to a repair shop or the like to repair air leakage, for example.

In the example shown in FIG. 5, when an engine stall has not occurred (NO at S1) or when the diagnosis condition is not satisfied (NO at S2), the process is returned to the main routine. Note that the processes of S3 and its subsequent steps may be performed, for example, periodically irrespective of an engine stall to diagnose the presence or absence of air leakage (an abnormal condition of the hose).

As described above, in the present embodiment, HV-ECU 110 performs motoring control to create a situation in which an airflow is to be formed in intake air passage 13, and determines whether the airflow has been actually formed based on a detection result of air flow meter 131. The present embodiment can thus diagnose the presence or absence of air leakage in intake air passage 13. Also, an existing air flow meter 131 can be used in the diagnosis of air leakage, and the installation of a new sensor is not required. This can reduce an increase in component cost.

The present embodiment has described the example in which forced induction device 15 is a turbocharger that boosts suctioned air with the use of exhaust energy. Alternatively, forced induction device 15 may be such a type of mechanical supercharger that drives a compressor with the use of the rotation of engine 10.

Although an embodiment of the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A hybrid vehicle comprising:
an engine including
an intake air passage,
a forced induction device provided in the intake air passage, and
a flow meter that detects a flow rate of air that passes through the intake air passage;
a motor coupled to the engine; and
a controller that performs motoring control of rotating a crankshaft of the engine by the motor,
wherein when the flow rate of air detected by the flow meter during the motoring control is less than a reference amount, the controller diagnoses air leakage as occurring in the intake air passage.

2. The hybrid vehicle according to claim 1, wherein when the engine is stalled, the controller performs the motoring control to diagnose presence or absence of an occurrence of air leakage in the intake air passage.

3. The hybrid vehicle according to claim 1, wherein
the forced induction device includes a compressor that compresses intake air to the intake air passage,
the engine further includes
an intercooler that is provided downstream of the compressor in the intake air passage and cools air that passes through the intake air passage, and
a throttle valve that is provided downstream of the compressor in the intake air passage and regulates the flow rate of air that passes through the intake air passage,
the intake air passage includes a hose connecting two of the compressor, the intercooler, and the throttle valve to each other, and
the air leakage occurs due to an abnormal condition of the hose in the intake air passage.

4. The hybrid vehicle according to claim 1, further comprising an intake pressure sensor that detects a pressure in an intake manifold of the engine, wherein
before diagnosing air leakage as occurring, the controller controls a fuel injection amount of the engine based on a detection result of the flow meter, and
after diagnosing air leakage as occurring, the controller controls the fuel injection amount based on a detection result of the intake pressure sensor.

5. A method of diagnosing an abnormal condition of a hybrid vehicle,
the hybrid vehicle including
an engine including
an intake air passage,
a forced induction device provided in the intake air passage, and
a flow meter that detects a flow rate of air that passes through the intake air passage, and
a motor coupled to the engine,
the method comprising:
performing motoring control of rotating a crankshaft of the engine by the motor; and
diagnosing air leakage as occurring in the intake air passage when the flow rate of air detected by the flow meter during the motoring control is less than a reference amount.
